(19) United States
(12) Patent Application Publication
(10) Pub. No.: US 2006/0191409 A1
(43) Pub. Date: Aug. 31, 2006

(54) Electrostatic switch for hydrogen storage and release from hydrogen storage media

(75) Inventors: Qinbai Fan, Chicago, IL (US); Michael Onischak, St. Charles, IL (US)

Correspondence Address: MARK E. FEJER;GAS TECHNOLOGY INSTITUTE, 1700 SOUTH MOUNT PROSPECT ROAD, DES PLAINES, IL, 60018, US

(73) Assignee: GAS TECHNOLOGY INSTITUTE

(21) Appl. No.: 11/410,485

(22) Filed: Apr. 25, 2006

Related U.S. Application Data
(63) Continuation-in-part of application No. 10/859,671, filed on Jun. 3, 2004.

(51) Int. Cl. B03C 3/155

(52) U.S. Cl. 95/61; 96/68

(57) ABSTRACT

A method and apparatus for storing molecular hydrogen in which a storage material suitable for storage of molecular hydrogen is electrostatically charged with a first electrostatic charge in the range of about 1V to about 100V, forming an electrostatically charged material and the electrostatically charged material is then contacted with molecular hydrogen, resulting in adsorption of the molecular hydrogen by the electrostatically charged material. The molecular hydrogen is released from the storage material by applying to the electrostatically charged material a second electrostatic charge having a polarity opposite to the first electrostatic charge.

### BACKGROUND OF THE INVENTION

1. Field of the Invention

This invention relates to a method and apparatus for storage and release of molecular gases, e.g. hydrogen, oxygen, chlorine, fluorine, etc. More particularly, this invention relates to a method and apparatus for storage and release of molecular gases in which the molecular gas storage medium may be electrostatically charged, and gas uptake by and release from the molecular gas storage medium is controlled by an electrostatic charger. Even more particularly, this invention relates to a method and apparatus for storage and release (adsorption and desorption) of molecular hydrogen.

2. Description of Related Art

Hydrogen is the most abundant element on earth and, because it is essentially non-polluting, forming water upon oxidation, it offers great potential as an energy source. Of particular interest is the use of hydrogen as an energy source in fuel cells for generation of power in stationary, portable and vehicular/transportation applications. However, cost-effective storage of hydrogen remains a significant barrier to the widespread use of hydrogen as an energy source. For vehicular/transportation applications, the overriding issue which needs to be addressed is storage of the amount of hydrogen required to provide a traditional driving range, at least about 300 miles, within the vehicular constraints of safety, weight, volume, efficiency and refueling times. More particularly, an effective hydrogen storage system for vehicular/transportation applications requires quick charge and discharge, high wt % storage capacity with small volumes, durability over many cycles, and safe handling and transport. Hydrogen storage is also a requirement for delivery of hydrogen from production sites, at hydrogen refueling stations and at stationary power sites.

One method for storing hydrogen having the potential to address these issues is storage in materials as “bonded” hydrogen. There are, at present, three basic paths known for storage of hydrogen in materials: absorption in which the hydrogen is absorbed directly into the absorbing material, such as metal hydrides; adsorption, which is comprised of both physisorption and chemisorption mechanisms, in which the hydrogen is energetically bound to the adsorbing material, such as carbon-based materials; and chemical reaction.

Hydrogen storage on carbon-based materials has been under investigation since the 1960's. The carbon-based materials include graphite, nanocarbon fibers, fullerenes, carbon nanotubes and nanohorns. Typical hydrogen storage capacities on carbon single-wall nanotubes have been reported in the range of about 2-4 wt %. In recent years, a substantial amount of investigation has focused on tubular shaped molecules for hydrogen storage. However, the cost of the materials is very high and the rates of hydrogen storage within these materials seem not to be reproducible. In addition, the temperatures required for storage of hydrogen in these materials are very low, e.g. on the order of liquid nitrogen, and the amount of power required to achieve even these relatively low amounts of hydrogen storage are very high.

Simonyan, et al., “Molecular Simulation of Hydrogen Adsorption in Charged Single-Walled Carbon Nanotubes”, Journal of Chemical Physics, Vol. 111, No. 21, December 1999, teaches the adsorption of molecular hydrogen gas onto charged single-walled nanotubes in which the quadrupole moment and induced dipole interaction of hydrogen with realistically charged (0.1 e/C) nanotubes leads to an increase in adsorption relative to the uncharged tubes of ˜10%-20% for T=298° K and 15%-30% for T=77° K. Simonyan et al. also teaches that in order to obtain significant densification of hydrogen at room temperature, electric fields on the order of 10¹ V/m and gradients on the order of 10²⁰ V/m are required. However, Simonyan et al. also teaches that, while it is possible to produce such strong electric fields and gradients through the use of lasers, this is not a useful technology for hydrogen storage due to the requirement of such large electric fields and gradients.

Hydrogen, which is a non-polar molecule, is typically physisorbed on carbon-based and other non-polar materials. The non-polar hydrogen molecules are adsorbed on the non-polar carbon-based material non-dissociately. The force between these two non-polar species is an intermolecular force, basically the weak Van der Waals force. However, increasing this weak adsorption force by the addition of a chemisorption component would increase the hydrogen storage capacity of the carbon-based substrate material.

### SUMMARY OF THE INVENTION

It is, thus, one object of this invention to provide a method and apparatus for storing gaseous molecules having an intermolecular affinity for electrons.

It is one object of this invention to provide a method and apparatus for controlled release upon demand of gaseous molecules, such as hydrogen, from a storage material storing the gaseous molecules.

It is one object of this invention to provide a method and apparatus for storing and releasing hydrogen.

It is another object of this invention to provide a method and apparatus for storing and releasing hydrogen whereby the amount of hydrogen able to be stored is increased over conventional hydrogen storage systems.

It is yet another object of this invention to provide a method and apparatus for storing hydrogen which provides reversible hydrogen storage, that is rapid charge and controlled discharge (adsorption and release) of the hydrogen.

It is still a further object of this invention to provide a method and apparatus for storing and releasing hydrogen which is suitable for use in vehicular/transportation applications.

It is still a further object of this invention to provide a method and apparatus for storing and releasing hydrogen which is operable with significantly weaker electric fields than known hydrogen storage systems.

These and other objects of this invention are addressed by method and apparatus for releasing gaseous molecules having an affinity for electrons from a gaseous molecule storage material storing the gaseous molecules in which the gaseous molecule storage material is electrostatically charged with a gaseous molecule-release electrostatic charge, resulting in release of the gaseous molecules from the gaseous molecule storage material.

These and other objects of this invention also are addressed by a method for storing gaseous molecules having an affinity for electrons comprising the steps of electrostatically charging a material suitable for storage of the gaseous molecules with a first electrostatic charge in the range of about 1V to about 100V to form an electrostatically charged material, and contacting the electrostatically charged material with the gaseous molecules, resulting in adsorption of the gaseous molecules by the electrostatically charged material. The gaseous molecules are desorbed or released by application of a second electrostatic charge to the electrostatically charged material, which second electrostatic charge has a polarity opposite to the polarity of the first electrostatic charge. Any material which is porous to the gaseous molecules, that is having internal spaces of sufficient size to accommodate the gaseous molecules, and which is capable of accepting an electrostatic charge is suitable as a material for storage of the gaseous molecules in accordance with this invention. In accordance with one preferred embodiment of this invention, the gaseous molecules are hydrogen molecules and preferred materials suitable for storage of the molecular hydrogen in accordance with one embodiment of this invention are carbon-based materials, e.g. graphite. Carbon-based materials offer the particular benefit relative to other materials suitable for storage of hydrogen, such as porous metals, of being lightweight.

These and other objects of this invention are also addressed by an apparatus for storage of gaseous molecules comprising a gaseous-molecule storage medium and charging means for electrostatically charging the gaseous-molecule storage medium. Any material which is porous to the gaseous molecules as described above and which is capable of accepting an electrostatic charge is suitable as a gaseous molecule storage medium. In accordance with one preferred embodiment of this invention, the storage medium is adapted for storing molecular hydrogen. Preferred materials for use as a molecular hydrogen storage medium in accordance with one embodiment of this invention are carbon-based materials. Particle sizes employed in the carbon-based materials in accordance with one preferred embodiment of this invention range from about 1 micron to about 150 microns in diameter.

It will be apparent to those skilled in the art that electrostatic charging of the gaseous-molecule storage material in accordance with one embodiment of this invention adds an electrical potential to the gaseous-molecule storage medium, thereby increasing the polarization of the gaseous-molecule storage material. In accordance with one embodiment of this invention, polarization of the gaseous-molecule storage material is further enhanced by the deposit and/or intercalation of electron-rich materials, such as metals, and/or electron hungry materials, such as nitrogen atoms, phosphor and the like.

Depending upon whether it is electron-rich or electron-poor, the gaseous-molecule storage medium of this invention may be positively or negatively charged for the adsorption of gaseous molecules. Release of the adsorbed gaseous molecules is achieved by reversing the polarity of the charge on the charged gaseous-molecule storage medium.

### BRIEF DESCRIPTION OF THE DRAWINGS

These and other objects and features of this invention will be better understood from the following detailed description taken in conjunction with the drawings wherein:

FIG. 1 is a schematic diagram showing modification of graphite flakes to produce a more suitable hydrogen storage material in accordance with one embodiment of this invention;

FIG. 2 is a schematic diagram of an electrostatic charger suitable for use in the method and apparatus of this invention;

FIG. 3 is a diagram showing hydrogen adsorption PCI (pressure vs. hydrogen content isotherm) curves of metal intercalated graphites under different voltages; and

FIG. 4 is a diagram showing hydrogen desorption PCI curves of metal intercalated graphites under different voltages.

### DETAILED DESCRIPTION OF THE PRESENTLY PREFERRED EMBODIMENTS

A fundamental element of the invention claimed herein is the application of an electrostatic charge to gaseous-molecule storage materials that are suitable for storage of gaseous molecules, such as molecular hydrogen, as a means for releasing the stored gaseous molecules from the gaseous-molecule storage materials. A further fundamental element of the invention claimed herein is the application of an electrostatic charge for increasing the storing capacity of the gaseous-molecule storage materials and the reversal of polarity of the electrostatic charge to release the stored gaseous molecules from the gaseous-molecule storage materials. Accordingly, any material having sufficient porosity to intake the gaseous molecules that is capable of accepting an electrostatic charge, be it positive or negative, may be employed in the method and apparatus of this invention. By sufficient porosity, we mean a porous material having sufficiently large open internal spaces to receive the gaseous molecules. Larger spaces may be employed and may, in fact, be desirable depending upon the amount of gaseous molecules desired to be stored. It will, however, be apparent to those skilled in the art that with larger spaces comes the potential for molecules larger than the desired gaseous molecules, e.g. water, and other impurities to enter the spaces of the storage material, thereby potentially reducing the storing capacity of the storage material. In such cases, it may be desirable to separate such larger molecules from the desired gaseous molecules prior to introducing the gaseous molecules into the gaseous-molecule storage material. It is to be understood that, although the focus of the description of this invention is on the storage of molecular hydrogen, the method and apparatus of this invention may be employed for storing any gaseous molecules having an intermolecular affinity for electrons, e.g. oxygen, chlorine, fluorine, H₂S, etc. and such gaseous molecules are deemed to be within the scope of this invention. Suitable gaseous-molecule storage materials include, but are not limited to, metals, zeolites, glass micro-spheres, alanates, magnesium alloys and carbon-based materials.

In accordance with one embodiment of this invention, the gaseous molecules are hydrogen molecules and the preferred hydrogen storage materials are carbon-based materials. As used herein, the term “carbon-based material” refers to a material comprising carbon. As previously indicated, carbon-based materials are generally lightweight and, as such, offer a highly favorable weight ratio of hydrogen storage material to stored hydrogen. In accordance with one preferred embodiment, the carbon-based material comprises an expanded (exfoliated) graphite material. Normal graphite is typically comprised of a plurality of graphite layers. However, the distances between adjacent graphite layers is generally less than the size of hydrogen molecules. As a result, in its naturally occurring state, graphite is generally unable to uptake significant amounts of hydrogen due to the insufficiency in the distance between adjacent graphite layers. However, expanded graphite as used in this invention is a carbon-based material which has been treated to increase the distance between adjacent graphite layers to an amount of at least about the diameter of molecular hydrogen.

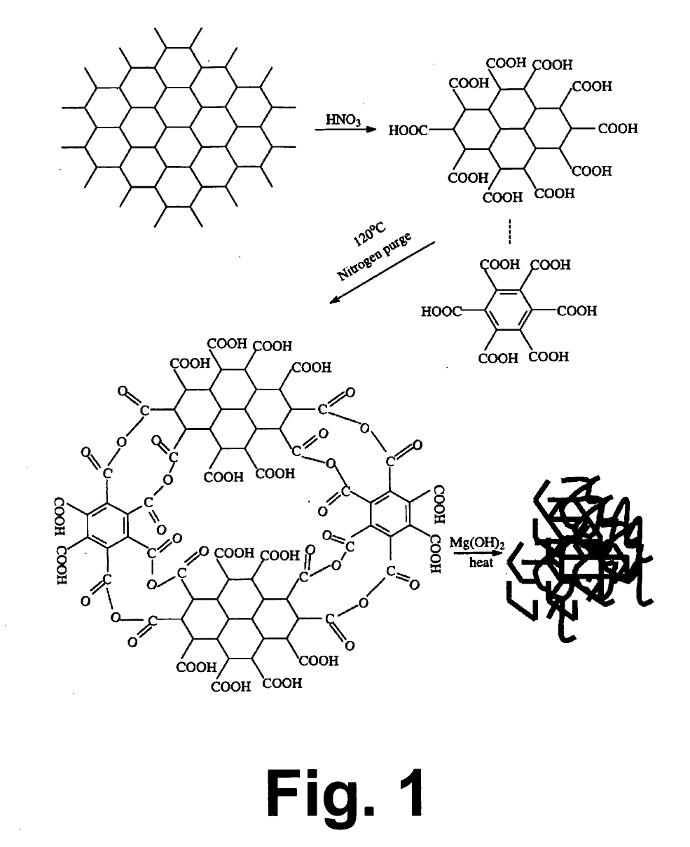

Expanded graphite is produced, as shown in FIG. 1, by first oxidizing a graphite powder, which may be in the form of flakes, particles, etc., using a strong acid solution. Preferred strong acid solutions are about 40 wt % HNO₃ and/or 40 wt % H₂SO₄. During this process, the acid molecules are inserted (intercalated) between the graphite layers, producing a “graphite salt” or expandable graphite. The expandable graphite is then heat treated at temperatures in the range of about 800° C. to about 1300° C., during which the acid molecules, before departing from the graphite structure, “push” the graphite layers apart, thereby producing an expanded graphite, that is, layered graphite having an increased interlayer distance, preferably greater than about the diameter of hydrogen molecules. In addition to increased distances between adjacent layers, expanded graphite exhibits electrical conductivity properties that are an order of magnitude higher than for non-expanded graphite.

During the graphite expansion process as shown in FIG. 1, oxidation of the graphite flakes with a strong acid produces carboxylic acid disposed around graphite flakes having different particle sizes. These oxidized graphite flakes may be dehydrated intra-molecularly and inter-molecularly. This procedure is dependent on time and temperature to form the different structural shapes, i.e. cage-type, twisted flakes, etc. The regrouped particles decarboxylate to remove carboxylic dehydrates at the same time. To prevent the expanded graphite material from compressing so as to reduce the distance between graphite layers to a distance less than the size of a hydrogen molecule, thereby preventing uptake by the graphite material of the hydrogen, in accordance with one embodiment of this invention, the decarboxylation process also intercalates electron-rich metals, for example Mg, which may be needed to back donate electrons to the p-band of the carbon atoms, thereby changing the carbon electronic configuration to change hydrogen adsorption from physisorption (nondissociative) to chemisorption (dissociative). The combination of physisorption and chemisorption of hydrogen on the modified carbon-based powders can improve the hydrogen storage capacities and the hydrogen charge and discharge cycles.

It will be apparent to those skilled in the art that other means for producing porous carbon-based materials suitable for use in the method and apparatus of this invention exist, and such other means and the materials produced thereby are deemed to be within the scope of this invention. One such method comprises the molding of suitably sized carbon particles into a desired shape, e.g. a plate, and sintering the molded plate, producing a porous carbon plate.

As previously indicated, in accordance with one embodiment of this invention, the carbon-based materials are intercalated or otherwise doped with materials suitable for back-donating electrons to the p-band, not only for the purpose of favorably altering the electrical properties of the carbon-based material, but also for the purpose of preventing reduction of the interlayer distances during use of the material. However, the back donation of electrons to the carbon p-band may not be enough to adsorb hydrogen at a maximum storage rate. In addition, back donation cannot control the hydrogen discharge or release when the hydrogen needs to be consumed. Thus, to enable them to adsorb more hydrogen, in accordance with one preferred embodiment of this invention, the carbon-based materials are electrostatically charged during hydrogen intake. When the hydrogen is needed, the polarity of the electrostatic charge is reversed to release the stored hydrogen.

In accordance with one preferred embodiment of this invention, the modified graphite materials are subjected to additional chemical intercalation or deposition of electron-rich materials with the preferred material being a metal which forms a hydride upon contact with the hydrogen. Which electron-rich metal is chosen depends upon the stability of the final materials and the quality of the hydrogen to be stored. In accordance with one preferred embodiment of this invention, the electron-rich metal is selected from the group of metals consisting of Mg, Li, Na, Ca, Ni, La, Fe, Ti and mixtures and alloys thereof. In accordance with a particularly preferred embodiment, the electron-rich metal is Mg, primarily due to the light weight of the metal and due to the fact that it is not as active as Li and Na. Intercalation can be conducted with the intercalant in any suitable physical form and concentration at temperatures and pressures effective to achieve the desired results in terms of composition of graphite intercalation compounds and their concentration in the material. Typically, the intercalant is in a liquid form and contains one or more first and second group of metals of the Periodic Table. Generally, the carbon-based materials are mixed with sulfuric acid and metal salts after which the mixture is sintered at a temperature suitable for decomposition of the salts.

Carbon-based materials, such as graphite flakes, as previously indicated, can be altered to produce different shapes as shown in FIG. 1. These synthetic graphite powders are different in shape from nanotubes, fullerenes and nanocarbon fibers but nevertheless are able to store more hydrogen than nanotubes, fullerenes and nanocarbon fibers due to their random shapes and controlled densities.

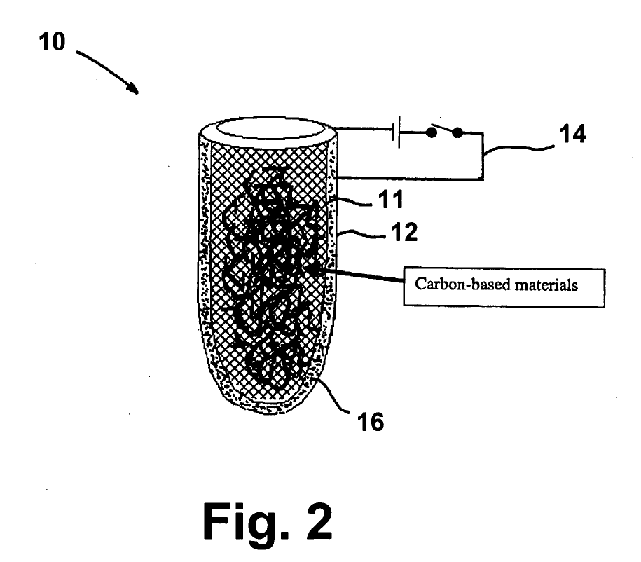

Once it has been modified to produce the desired shape(s), the carbon-based material is placed in a suitable containment vessel, such as an electrostatic Faraday cage as shown in FIG. 2. The electrostatic cage 10 comprises an inner wire mesh cylinder 11 as a charger distributor and container and an outer wire mesh 12, which could be a metal alloy tank, disposed at a distance from the inner wire mesh cylinder 11, as a shield. When charged carbon-based materials are placed inside the closed conducting mesh cylinder 11, they produce equal charges on the outside of the cylinder surface. When a charge producer, e.g. electrostatic charger 14, is applied, the inner surface becomes charged, which immediately balances to the inside carbon-based materials, which have the same amount of charges. A potential is produced between the inner side mesh cylinder 11 and the outside cylinder 12. The greater the charge, the greater the potential is. To prevent discharge or sparks between the inner wire mesh cylinder and the outer wire mesh cylinder, an insulation layer 16 is disposed between the two wire mesh cylinders. When the inner wire mesh cylinder is charged, the carbon-based materials are charged and the hydrogen can be introduced into the inner cylinder. When the stored hydrogen is needed, the charger is turned off to reduce the charges on the carbon-based materials so that the hydrogen can be easily released.

Preferred electrostatic charges employed range from about 1V to about 100V. Particle sizes range from about 1 micron to about 150 microns. Operating temperature for the apparatus is in a range where the molecules to be stored are in a gaseous state. Operating temperature for the apparatus where the molecules to be stored are hydrogen is preferably in the range of about −20° C. to about 200° C., which range corresponds to the range of operating temperature requirements for vehicular/transportation applications of the claimed invention. By way of comparison, Simonyan et al. indicates that an electric field on the order of about 10¹⁰ V/m is required to obtain significant hydrogen storage. Surprisingly, we have found that significant hydrogen storage can be obtained with significantly smaller electric fields, on the order of about 10⁴ V/m smaller for comparable sized particles.

As previously indicated, the gaseous molecule storage materials employed in this invention may be electrostatically charged with positive or negative charges, the choice of which depends upon the material used. For electron-rich materials, that is materials which readily form hydrides upon exposure to hydrogen, such as first and second group metals of the Periodic Table, e.g. Mg, Li, Na, Ca, Ni, La, Fe, Ti and mixtures and alloys thereof, a positive electrostatic charge is applied for intake of the gaseous molecules and a negative electrostatic charge is applied for discharge of the gaseous molecules. It will be appreciated by those skilled in the art that affinity of at least some electron-rich materials to hydrogen is such that no electrostatic charging of the storage materials is required for the uptake of hydrogen. Electron-rich materials naturally have a strong affinity to hydrogen to form hydrides; however, they do not readily release the H⁻ ions due to the strong affinity in the form of a chemical bond between the H⁻ ions and the electron-rich materials. Accordingly, in accordance with one embodiment of this invention, a positive electrostatic charge is applied to the electron-rich gaseous molecule storage material for adsorption of hydrogen, reducing the availability of electrons for bonding with the H⁻ ions, and, thus, weakening the affinity between hydrogen and the electron-rich materials and enabling desorption of the hydrogen upon application of a negative electrostatic charge to the gaseous molecule storage material.

By comparison, gaseous molecule storage materials that are electron-poor, that is materials which do not readily form hydrides upon exposure to hydrogen, such as carbon-based materials and zeolites, have a relatively low affinity for hydrogen. Thus, application of a negative electrostatic charge enhances the affinity between the gaseous molecule storage material and hydrogen, thereby promoting the intake of hydrogen by the gaseous molecule storage material. Desorption or release of the hydrogen from the gaseous molecule storage material is achieved by applying a positive electrostatic charge.

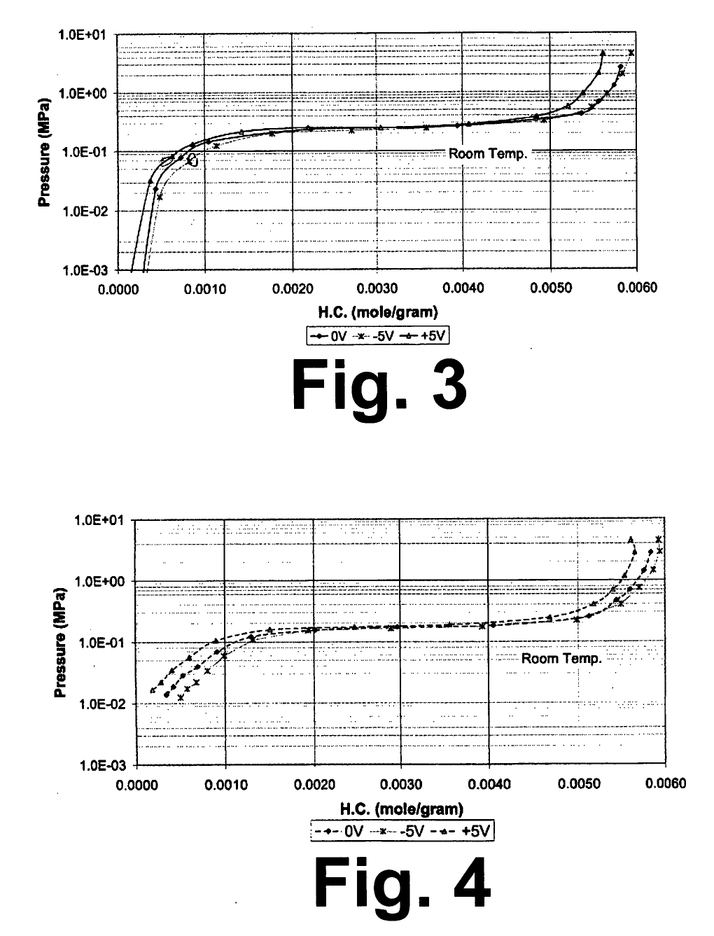

FIG. 3 shows the hydrogen adsorption PCI curves for metal intercalated graphites at 0V, −5V and +5V and FIG. 4 shows the hydrogen desorption PCI curves for metal intercalated graphites at 0V, −5V and +5V. Surprisingly, the positive charge shifts the PCI curves to the left, representing a decrease in hydrogen adsorption compared to no charge (0V), and the negative charge shifts the PCI curves to the right, representing an increase in hydrogen adsorption compared to no charge. Control of the hydrogen adsorption and desorption may be external to the overall hydrogen adsorption/desorption system.

While in the foregoing specification this invention has been described in relation to certain preferred embodiments thereof, and many details have been set forth for purpose of illustration, it will be apparent to those skilled in the art that the invention is susceptible to additional embodiments and that certain of the details described herein can be varied considerably without departing from the basic principles of the invention.

We claim:

1. A method for releasing hydrogen from a hydrogen storage material storing said hydrogen comprising the steps of:
electrostatically charging said hydrogen storage material with a hydrogen-release electrostatic charge, resulting in release of said hydrogen from said hydrogen storage material.

2. A method in accordance with claim 1, wherein said hydrogen is stored by electrostatically charging said hydrogen storage material with a hydrogen-storage electrostatic charge, forming an electrostatically charged hydrogen storage material, and contacting said electrostatically charged hydrogen storage material with said hydrogen, resulting in adsorption of said hydrogen by said electrostatically charged hydrogen storage material.

3. A method in accordance with claim 2, wherein said hydrogen-storage electrostatic charge as a polarity opposite of said hydrogen-release electrostatic charge.

4. A method in accordance with claim 2, wherein said hydrogen-storage electrostatic charge is in a range of about 1V to about 100V.

5. A method in accordance with claim 1, wherein said hydrogen storage material is a hydrogen-porous, electrostatically chargeable material.

6. A method in accordance with claim 2, wherein said hydrogen storage material is an electron-rich material.

7. A method in accordance with claim 6, wherein said hydrogen-storage electrostatic charge is a positive electrostatic charge.

8. A method in accordance with claim 2, wherein said hydrogen storage material is an electron-poor material.

9. A method in accordance with claim 8, wherein said hydrogen-storage electrostatic charge is a negative electrostatic charge.

10. A method in accordance with claim 8, wherein said hydrogen storage material is a carbon-based material.

11. A method in accordance with claim 10, wherein said carbon-based material comprises an exfoliated graphite.

12. A method in accordance with claim 10, wherein at least one electron-rich metal is at least one of intercalated and deposited on said carbon-based material.

13. A method in accordance with claim 12, wherein said electron-rich metal is able to form a hydride upon contact with said hydrogen.

14. A method in accordance with claim 12, wherein said at least one electron-rich metal is selected from the group consisting of Mg, Li, Na, Ca, Ni, La, Fe, Ti and mixtures and alloys thereof.

15. A method in accordance with claim 1, wherein said hydrogen storage material is at a temperature in a range of about −20° C. to about 200° C.

16. A method in accordance with claim 1, wherein said hydrogen storage material comprises a metal selected from the group consisting of Mg, Li, Na, Ca, Ni, La, Fe, Ti and mixtures and alloys thereof.

17. An apparatus for storage and release of gaseous molecules comprising:
a gaseous molecule storage medium; and
gaseous molecule release charging means for electrostatically charging said gaseous molecule storage medium and releasing said gaseous molecules from said gaseous molecule storage medium.

18. An apparatus in accordance with claim 17 further comprising gaseous molecule storage charging means for electrostatically charging said gaseous molecule storage medium and adsorbing said gaseous molecules.

19. An apparatus in accordance with claim 18, wherein said gaseous molecule storage charging means produces an electrostatic charge in a range of about 1V to about 100V.

20. An apparatus in accordance with claim 18, wherein said gaseous molecule storage charging means and said gaseous molecule release charging means produce opposite polarity electrostatic charges during storing and releasing of said gaseous molecules.

21. An apparatus in accordance with claim 17, wherein said gaseous molecule storage medium comprises one of an electron-rich material and an electron-poor material.

22. An apparatus in accordance with claim 21, wherein said electron-poor material is a carbon-based material.

23. An apparatus in accordance with claim 22, wherein said carbon-based material is an exfoliated graphite.

24. An apparatus in accordance with claim 22, wherein said carbon-based material is intercalated with at least one electron-rich metal.

25. An apparatus in accordance with claim 24, wherein said at least one electron-rich metal is able to form a metal hydride upon contact with molecular hydrogen.

26. An apparatus in accordance with claim 25, wherein said electron-rich metal is selected from the group consisting of Mg, Li, Na, Ca, Ni, La, Fe, Ti and mixtures and alloys thereof.

27. An apparatus in accordance with claim 22, wherein said carbon-based material comprises a plurality of layers, a distance between said layers being at least about a diameter of said gaseous molecule to be stored.

28. An apparatus in accordance with claim 22, wherein said carbon-based material is disposed in a Faraday cage.

29. A method for releasing gaseous molecules from a gaseous molecule storage material storing said gaseous molecules comprising the steps of:
electrostatically charging said gaseous molecule storage material with a gaseous molecule-release electrostatic charge, resulting in release of said gaseous molecules from said gaseous molecule storage material.

30. A method in accordance with claim 29, wherein said gaseous molecules are stored by electrostatically charging said gaseous molecule storage material with a gaseous molecule-storage electrostatic charge, forming an electrostatically charged gaseous molecule storage material, and contacting said gaseous molecule storage material with said gaseous molecules, resulting in adsorption of said gaseous molecules by said electrostatically charged gaseous molecule storage material.

31. A method in accordance with claim 30, wherein said gaseous molecule-storage electrostatic charge has a polarity opposite of said gaseous molecule-release electrostatic charge.

32. A method in accordance with claim 29, wherein said gaseous molecules are diatomic molecules.

33. A method in accordance with claim 29, wherein said gaseous molecules are hydrogen molecules.

34. A method in accordance with claim 30, wherein said gaseous molecule-storage electrostatic charge is in a range of about 1V to about 100V.

35. A method in accordance with claim 29, wherein said gaseous molecule storage material is a gaseous molecule-porous, electrostatically chargeable material.

36. A method in accordance with claim 30, wherein said gaseous molecule storage material is an electron-rich material.

37. A method in accordance with claim 36, wherein said gaseous molecule-storage electrostatic charge is a positive electrostatic charge.

38. A method in accordance with claim 30, wherein said gaseous molecule storage material is an electron-poor material.

39. A method in accordance with claim 38, wherein said gaseous molecule-storage electrostatic charge is a negative electrostatic charge.

40. A method in accordance with claim 38, wherein said gaseous molecule storage material is a carbon-based material.
